(19) United States
(12) Patent Application Publication
(10) Pub. No.: US 2015/0031327 A1
(43) Pub. Date: Jan. 29, 2015

(54) CELL DEVICE PLANNING TOOL

(71) Applicants: Cellco Partnership d/b/a Verizon Wireless, Basking Ridge, NJ (US); Verizon Patent and Licensing Inc., Basking Ridge, NJ (US)

(72) Inventors: Scott A. TOWNLEY, Gilbert, AZ (US); Richard M. Vandoren, Benicia, CA (US); Todd R. Michels, Phoenix, AZ (US); Derek Hongwei H. Bao, Concord, CA (US)

(73) Assignees: Cellco Partnership d/b/a Verizon Wireless, Basking Ridge, NJ (US); Verizon Patent and Licensing Inc., Basking Ridge, NJ (US)

(21) Appl. No.: 13/950,875

(22) Filed: Jul. 25, 2013

(51) Int. Cl. H04W 16/18

(52) U.S. Cl. CPC H04W 16/18
USPC 455/405

(57) ABSTRACT

A device is configured to receive signal information and demand information associated with a set of cell devices in a network. The device is configured to determine time usage information, based on the signal information and based on the demand information, and to provide the time usage information. The device is configured to determine a proposed cell device, for the network, based on the time usage information, and to determine modified signal information based on the proposed cell device and based on the signal information. The device is configured to determine modified time usage information based on the modified signal information, and to provide the modified time usage information.

### BACKGROUND

A cell device (e.g., a base station, an eNB, an access point, etc.) may be placed in a geographic region with other cell devices to form a network (e.g., a wireless network, a cellular network, etc.). The network may transmit and/or receive network information, such as voice calls, video calls, emails, short message service (“SMS”) text messages, or the like. Additional cell devices may be joined to the network to increase network capacity, improve signal strength, provide additional network coverage, or the like.

### BRIEF DESCRIPTION OF THE DRAWINGS

FIG. 1 is a diagram of an overview of an example implementation described herein;

FIG. 2 is a diagram of an example environment in which systems and/or methods described herein may be implemented;

FIG. 3 is a diagram of example components of one or more devices of FIG. 2;

FIG. 4 is a flow chart of an example process for determining time usage information associated with a set of cell devices;

FIGS. 5A-5B are diagrams of an example implementation relating to the example process shown in FIG. 4;

FIG. 6 is a flow chart of an example process for determining time usage information associated with a proposed cell device; and

FIG. 7 is a diagram of an example implementation relating to the example process shown in FIG. 6.

### DETAILED DESCRIPTION OF PREFERRED EMBODIMENTS

The following detailed description of example implementations refers to the accompanying drawings. The same reference numbers in different drawings may identify the same or similar elements.

An engineer associated with a planning device (e.g., a computer) may desire to add a proposed cell device to a network (e.g., a set of cell devices, such as base stations, eNBs, access points, etc.) in order to increase the network's capacity, size, or the like. The planning device may determine the proposed cell device based on signal information associated with the set of cell devices (e.g., cell device locations, cell device types, cell device signal attributes, cell device coverage areas, etc.), and based on demand information associated with the set of cell devices (e.g., a quantity of network information transmitted between the set of cell devices and a set of user devices during a period of time).

However, the efficiency of the network may depend on a quantity of time associated with the transmission of network information. For example, network information transmitted between a user device and a cell device may pass through the network more quickly when the user device is closer to the cell device than when the user device is farther from the cell device. Thus, even regions of moderate and/or low network information demand may strain the network due to slow transmission times (e.g., due to a poor signal quality between the user device and the cell device). Implementations described herein may allow a planning device to determine time usage information (e.g., information that identifies how quickly network information is transmitted between the set of user devices and the set of cell devices) and, based on the time usage information, may determine how the placement of a proposed cell device may affect signals associated with the set of cell devices.

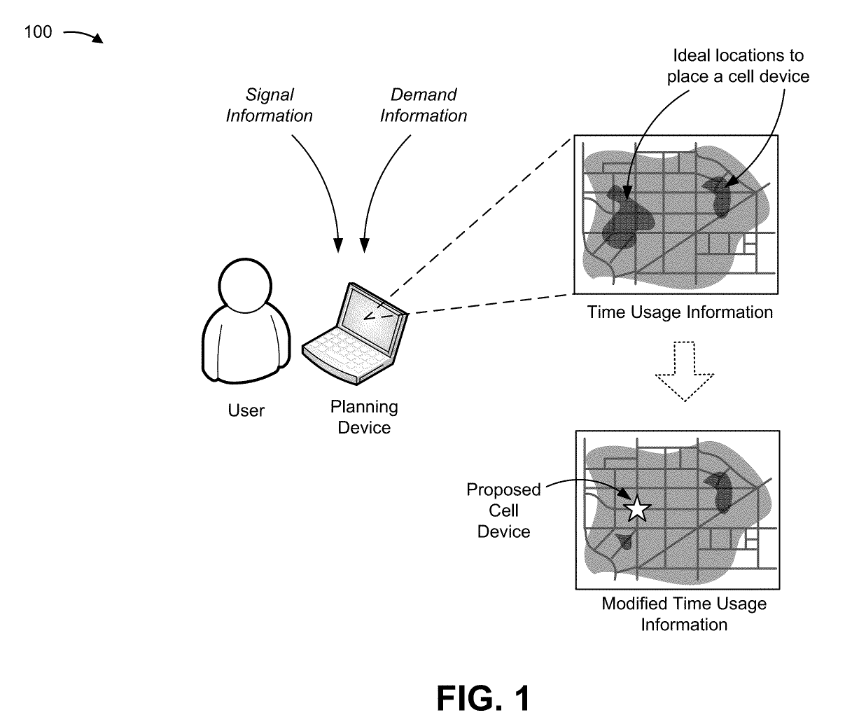

FIG. 1 is a diagram of an overview of an example implementation 100 described herein. As shown in FIG. 1, example implementation 100 may include a planning device. The planning device may receive and/or provide information helpful in determining where a cell device (e.g., an access point, a base station, etc.) may be placed in a network.

As shown in FIG. 1, the planning device may receive signal information and demand information. The signal information may include signal characteristics (e.g., intensity, frequency, etc.) associated with a set of cell devices forming a network. The demand information may include information that identifies a quantity of network information demanded during a period of time. Based on the signal information and the demand information, the planning device may determine time usage information. The time usage information may include information that identifies how quickly network information (e.g., voice calls, emails, SMS text messages, etc.) passes through the network (e.g., a measure of a quantity of time for the network information to be transmitted between a set of user devices and the set of cell devices).

As further shown in FIG. 1, the planning device may determine a proposed cell device based on user input from a user associated with the planning device. Based on the proposed cell device, the planning device may determine modified time usage information. The modified time usage information may include information that identifies how quickly network information is transmitted between the set of user devices and a proposed set of cell devices (e.g., the set of cell devices and the proposed cell device). In this manner, the planning device may determine how the proposed cell device may affect transmission of network information, and may assist a user of the planning device in determining a geographic location and a device type for the proposed cell device.

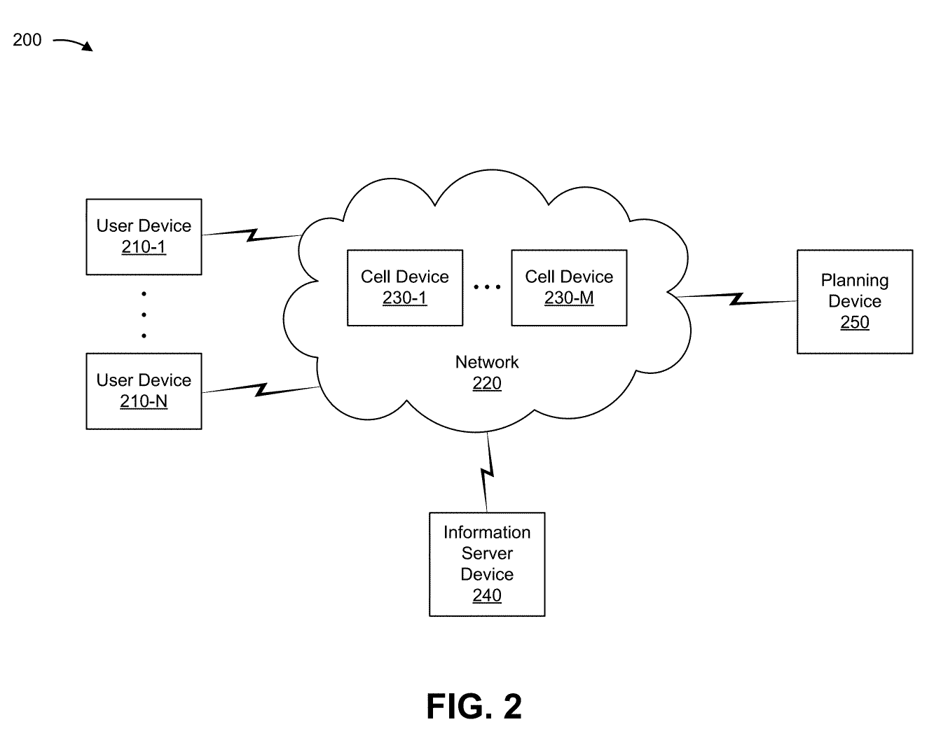

FIG. 2 is a diagram of an example environment 200 in which systems and/or methods described herein may be implemented. As shown in FIG. 2, environment 200 may include user devices 210-1 . . . 210-N (N≧1) (hereinafter referred to collectively as “user devices 210,” and individually as “user device 210”), a network 220, cell devices 230-1 . . . 230-M (M≧1) (hereinafter referred to collectively as “cell devices 230,” and individually as “cell device 230”), an information server device 240, and a planning device 250. Devices of environment 200 may interconnect via wired connections, wireless connections, or a combination of wired and wireless connections.

User device 210 may include a device capable of receiving and/or transmitting information, such as information associated with a voice call, a video call, an email, a short message service (e.g., “SMS”) text message, or the like. For example, user device 210 may include a mobile telephone (e.g., a smartphone, a radiotelephone, etc.), a computing device (e.g., a desktop computer, a laptop computer, a tablet computer, a handheld computer, etc.), or a similar device. User device 210 may transmit information to and/or receive information from cell device 230, information server device 240, and/or planning device 250.

Network 220 may include one or more wired and/or wireless networks. For example, network 220 may include a cellular network, a public land mobile network (“PLMN”), a second generation (“2G”) network, a third generation (“3G”) network, a fourth generation (“4G”) network, a fifth generation (“5G”) network, a long term evolution (“LTE”) network, and/or another network. Additionally, or alternatively, network 220 may include a local area network (“LAN”), a wide area network (“WAN”), a metropolitan area network (“MAN”), a telephone network (e.g., the Public Switched Telephone Network (“PSTN”)), a WiFi network, an ad hoc network, an intranet, the Internet, a fiber optic-based network, or a combination of these or other types of networks.

Network 220 may host cell device 230. Cell device 230 may include one or more devices that receive, process, and/or transmit traffic, such as media, audio, video, text, and/or other traffic, destined for and/or received from user device 210. In some implementations, cell device 230 may include an eNB associated with a LTE network that receives traffic from and/or sends traffic to network 220 via a packet data network gateway and/or a serving gateway. Additionally, or alternatively, one or more cell device 230 may be associated with a RAN that is not associated with an LTE network. Cell device 230 may send traffic to and/or receive traffic from user device 210 via an air interface. In some implementations, cell device 230 may be associated with a small cell, such as a microcell, a picocell, and/or a femtocell. Additionally, or alternatively, cell device may include a base station, an access point (e.g., a wireless access point), or the like.

Information server device 240 may include one or more devices capable of receiving, storing, processing, and/or transmitting information, such as information associated with communications between user device 210 and cell device 230. For example, information server device 240 may include a computing device, such as a server, a desktop computer, a laptop computer, a tablet computer, a handheld computer, or a similar device. Information server device 240 may receive information from and/or transmit information to user device 210, cell device 230, and/or planning device 250.

Planning device 250 may include a device capable of determining information associated with a proposed cell device 230. For example, user device 210 may include a desktop computer, a laptop computer, a tablet computer, a handheld computer, a server device, or a similar device. In some implementations, planning device 250 may include a display that outputs information from planning device 250 and/or that allows a user to provide input to planning device 210. Additionally, or alternatively, user device 210 may receive information from and/or transmit information to user device 210, cell device 230, and/or information server device 240.

The number of devices and networks shown in FIG. 2 is provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, one or more of the devices of environment 200 may perform one or more functions described as being performed by another one or more devices of environment 200.

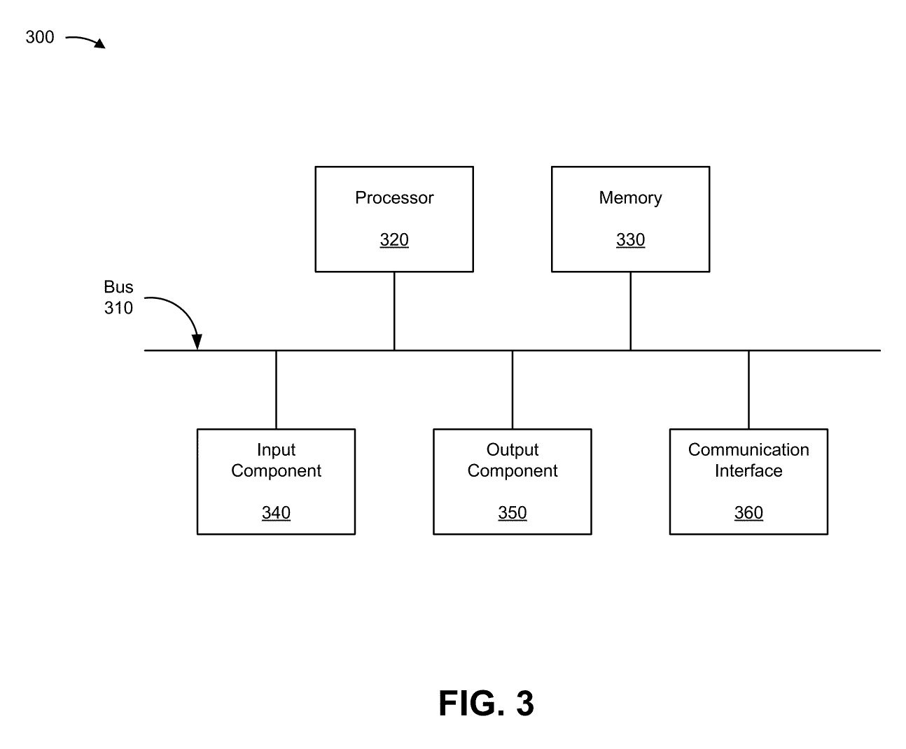

FIG. 3 is a diagram of example components of a device 300. Device 300 may correspond to user device 210, cell device 230, information server device 240, and/or planning device 250. Additionally, or alternatively, each of user device 210, cell device 230, information server device 240, and/or planning device 250 may include one or more devices 300 and/or one or more components of device 300. As shown in FIG. 3, device 300 may include a bus 310, a processor 320, a memory 330, an input component 340, an output component 350, and a communication interface 360.

Bus 310 may include a path that permits communication among the components of device 300. Processor 320 may include a processor (e.g., a central processing unit, a graphics processing unit, an accelerated processing unit), a microprocessor, and/or any processing component (e.g., a field-programmable gate array (“FPGA”), an application-specific integrated circuit (“ASIC”), etc.) that interprets and/or executes instructions. Memory 330 may include a random access memory (“RAM”), a read only memory (“ROM”), and/or another type of dynamic or static storage device (e.g., a flash, magnetic, or optical memory) that stores information and/or instructions for use by processor 320.

Input component 340 may include a component that permits a user to input information to device 300 (e.g., a touch screen display, a keyboard, a keypad, a mouse, a button, a switch, etc.). Output component 350 may include a component that outputs information from device 300 (e.g., a display, a speaker, one or more light-emitting diodes (“LEDs”), etc.).

Communication interface 360 may include a transceiver-like component, such as a transceiver and/or a separate receiver and transmitter, that enables device 300 to communicate with other devices, such as via a wired connection, a wireless connection, or a combination of wired and wireless connections. For example, communication interface 360 may include an Ethernet interface, an optical interface, a coaxial interface, an infrared interface, a radio frequency (“RF”) interface, a universal serial bus (“USB”) interface, or the like.

Device 300 may perform various operations described herein. Device 300 may perform these operations in response to processor 320 executing software instructions included in a computer-readable medium, such as memory 330. A computer-readable medium may be defined as a non-transitory memory device. A memory device may include memory space within a single physical storage device or memory space spread across multiple physical storage devices.

Software instructions may be read into memory 330 from another computer-readable medium or from another device via communication interface 360. When executed, software instructions stored in memory 330 may cause processor 320 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number of components shown in FIG. 3 is provided for explanatory purposes. In practice, device 300 may include additional components, fewer components, different components, or differently arranged components than those shown in FIG. 3.

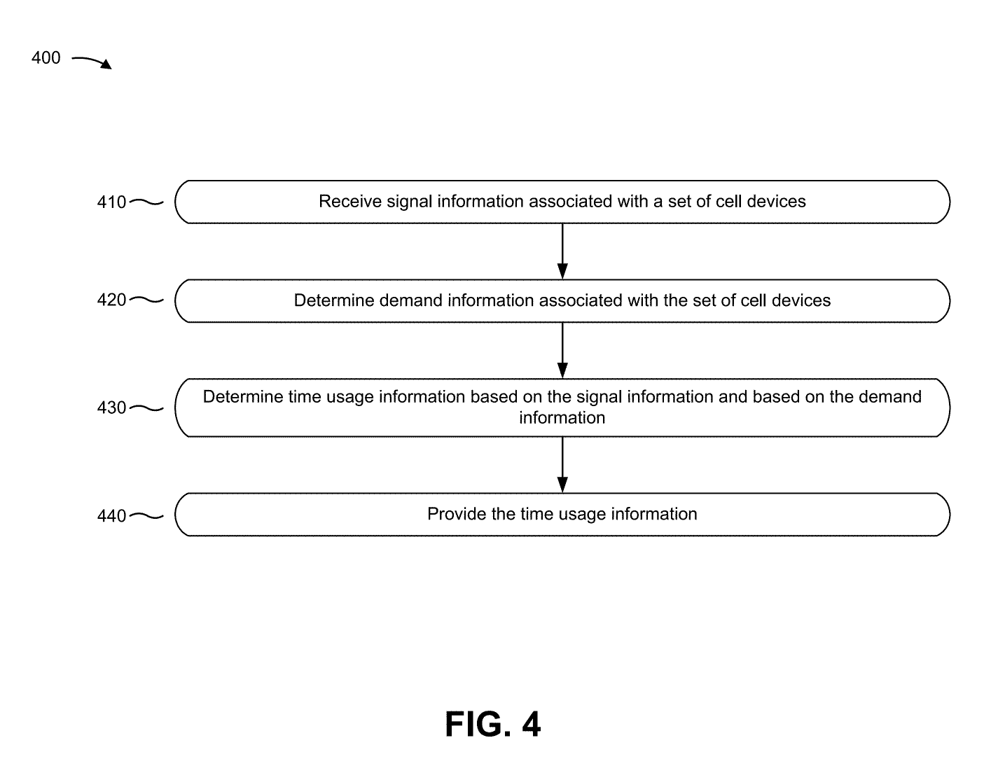

FIG. 4 is a flow chart of an example process 400 for determining time usage information associated with a set of cell devices. In some implementations, one or more process blocks of FIG. 4 may be performed by planning device 250. Additionally, or alternatively, one or more process blocks of FIG. 4 may be performed by another device or a group of devices separate from or including planning device 250, such as user device 210, cell device 230, and/or information server device 240.

As shown in FIG. 4, process 400 may include receiving signal information associated with a set of cell devices (block 410). For example, planning device 250 may receive the signal information from information server device 240 associated with the set of cell devices 230. Additionally, or alternatively, planning device 250 may receive the signal information from cell devices 230.

In some implementations, the signal information may include information that describes properties of a signal (e.g., an electromagnetic signal, a radio frequency (“RF”) signal, a cellular signal, etc.) associated with cell device 230. For example, the signal information may include properties associated with a signal of cell device 230, such as a signal strength, a signal intensity, a signal frequency, a power output, or the like.

In some implementations, the signal information may include information determined from measurements of the signal associated with cell device 230 (e.g., actual signal information). Additionally, or alternatively, the signal information may include information determined based on properties associated with cell device 230, such as a type of cell device 230, a geographic location of cell device 230, a topology of objects surrounding cell device 230, or the like (e.g., calculated signal information).

In some implementations, the signal information may include information that describes a location of cell device 230. For example, the signal information may include a geographic location of cell device 230, a height of cell device 230, a direction of cell device 230, or the like. In some implementations, the signal information may include information that describes a device type associated with cell device 230. For example, the signal information may include whether cell device 230 is an eNB, a base station, an access point, associated with a small cell, associated with a macrocell, or the like.

In some implementations, the signal information may include topographical information (e.g., information associated with one or more artificial and/or natural physical features of a geographic region). For example, the signal information may include information that identifies properties associated with an object within a threshold proximity of cell device 230, such as a building, a mountain, a hill, a tree, or the like. The properties may include an object location, an object density, an object size, or the like. In some implementations, the signal information may include information that identifies how the object affects a signal produced by cell device 230 (e.g., an extent of signal interference produced by the object).

In some implementations, the signal information may include information that describes a location, an availability, a proximity, or the like, of other networks and/or other portions of network 220 (e.g., a backhaul portion of network 220). For example, the signal information may include information that describes a geographic location associated with a connection point to a core network (e.g., associated with network 220). In some implementations, planning device 250 may determine a proximity between the connection point and cell device 250.

As further shown in FIG. 4, process 400 may include determining demand information associated with the set of cell devices (block 420). For example, planning device 250 may receive the demand information, associated with cell devices 230, from information server device 240. Additionally, or alternatively, planning device 250 may receive the demand information from cell devices 230.

In some implementations, the demand information may include information that identifies a quantity of network information demanded during a period of time (e.g., a quantity of information transmitted and/or received by cell device 230). Network information may include information transmitted through network 220 by use of cell device 230. For example, network information may include a voice call, a video call, an SMS text message, an email, or the like, transmitted between user device 210 and cell device 230.

In some implementations, planning device 250 may determine the demand information based on a history of network information usage associated with a set of user devices 210 (e.g., a set of user devices 210 within a geographic region, a set of user devices 210 associated with the set of cell devices 230, a set of user devices 210 associated with a particular cell, etc.). For example, planning device 250 may receive, from information server device 240, a record of calls (e.g., voice calls, video calls, downloads, uploads, text messages, etc.) made by the set of user devices 210. The record of calls may include information that identifies a call time, a call duration, a quantity of network information transmitted during the call (e.g., a quantity of megabytes), or the like.

In some implementations, planning device 250 may determine a geographic location associated with user device 210 at the time of a call (e.g., a call included in the record of calls). For example, planning device 250 may determine the geographic location associated with the call based on trilateration (e.g., by determining the geographic location of user device 210 based on measuring the distance from cell device 230 to user device 210), triangulation (e.g., by determining the geographic location of user device 210 based on angles from user device 210 to a known baseline), multilateration (e.g., by determining the geographic location of user device 210 based on a measurement of the difference in distance between two or more cell devices 230 at known locations broadcasting signals at known times), or the like.

In some implementations, planning device 250 may aggregate the demand information based on the geographic location. For example, planning device 250 may determine a quantity of demand information associated with the geographic location during a period of time (e.g., an hour, a day, a month, etc.). In some implementations, the geographic location may include an area, such as a city block, a square mile, a region within a circle of a defined radius, a coverage area of a cell, or the like. In this manner, the planning device 250 may determine the quantity of demand information associated with the geographic location (e.g., a quantity of megabytes consumed by user devices 210 at the geographic location during the time period).

In some implementations, planning device 250 may determine the demand information associated with cell device 230 (e.g., a load amount). For example, planning device 250 may determine the demand information associated with cell device 210 by determining a quantity of network information (e.g., megabytes) processed by cell device 210 during the period of time (e.g., a quantity of calls processed by cell device 230).

As further shown in FIG. 4, process 400 may include determining time usage information based on the signal information and based on the demand information (block 430). For example, planning device 250 may determine the time usage information based on the signal information and the demand information received from information server device 240.

In some implementations, the time usage information may include a measure of an amount of time for the network information to be transmitted between user device 210 and cell device 230. For example, the time usage information may include a measure of the network information (e.g., megabytes transmitted between user devices 210 and cell device 230) per delivered throughput. The delivered throughput may include a rate of information (e.g., megabytes per second) received and/or transmitted by cell device 230 (e.g., a rate of network information transmitted via network 220).

In some implementations, the delivered throughput may depend on the signal quality experienced by user device 210 while transmitting and/or receiving network information (e.g., during a time of active use). For example, user device 210 may experience a higher quality of signal when user device 210 is closer to cell device 230. When experiencing a higher quality of signal, network information may pass more quickly between user device 210 and network 220. Likewise, user device 210 may experience a lower quality of signal when user device 210 is farther from cell device 230. In this instance, network information may pass more slowly between user device 210 and network 220.

In some implementations, planning device 250 may determine the time usage information based on the demand information. For example, planning device 250 may determine an average amount of network information processed by the set of cell devices 230 (e.g., an average load) based on the demand information. Based on the average load, planning device 250 may determine an effective average total transmitted power associated with the set of cell devices 230. Planning device 250 may determine signal-to-interference-plus-noise ratios (e.g., “SINRs”), associated with the set of cell devices 230, based on the total transmitted power and based on the signal information (e.g., based on signal levels associated with the set of cell devices 230 in a geographic location). Planning device 250 may spatially correlate the SINRs with the demand information. Based on the spatially correlated SINRs and the demand information, planning device 250 may determine the delivered throughput associated with cell devices 230 in a geographic region (e.g., planning device 250 may determine a quantity of network information transmitted and/or received by cell device 230 associated with a set of geographic locations). In this manner, planning device 250 may determine the time usage information (e.g., the quantity of network information demanded per delivered throughput).

In some implementations, planning device 250 may determine geographic regions associated with a low time usage (e.g., a time usage less than a threshold time usage). For example, planning device 250 may determine a geographic region associated with low network information demand and high delivered throughput. Likewise, planning device 250 may determine a geographic region associated with high network information demand and high delivered throughput (e.g., a delivered throughput large enough that the time usage may be below the threshold time usage).

In some implementations, planning device 250 may determine geographic regions associated with high time usage (e.g., a time usage greater than a threshold time usage). For example, planning device 250 may determine a geographic region associated with high network information demand and low delivered throughput. Likewise, planning device 250 may determine a geographic region associated with low network information demand and low delivered throughput (e.g., network demand information large enough that the time usage may be above the threshold time usage).

As further shown in FIG. 4, process 400 may include providing the time usage information (block 440). For example, planning device 250 may provide the time usage information to another device and/or set of devices, such as user device 210, cell device 230, and/or information server device 250.

In some implementations, planning device 250 may display the time usage information on a display associated with planning device 250 (e.g., via a user interface). In some implementations, planning device 250 may display the time usage information as a map (e.g., a time usage map). For example, planning device 250 may display the time usage information as a map of geographic locations, with darker regions of the map displaying a higher quantity of time for transmitting and/or receiving network information. In some implementations, the time usage map may display related information (e.g., related signal information, related demand information, etc.). For example, planning device 250 may display, along with the time usage map, a location associated with cell device 230, a type associated with cell device 230, a quantity of network information processed by cell device 230 (e.g., a load), an object, an object location, or the like.

In some implementations, planning device 250 may provide the signal information and/or the demand information. For example, planning device 250 may provide a map of the signal information and/or a map of the demand information. In some implementations, the map of the signal information and the map of the demand information may be associated with (e.g., overlaid on) the time usage map.

Although FIG. 4 shows example blocks of process 400, in some implementations, process 400 may include additional blocks, different blocks, fewer blocks, or differently arranged blocks than those depicted in FIG. 4. Additionally, or alternatively, one or more of the blocks of process 400 may be performed in parallel.

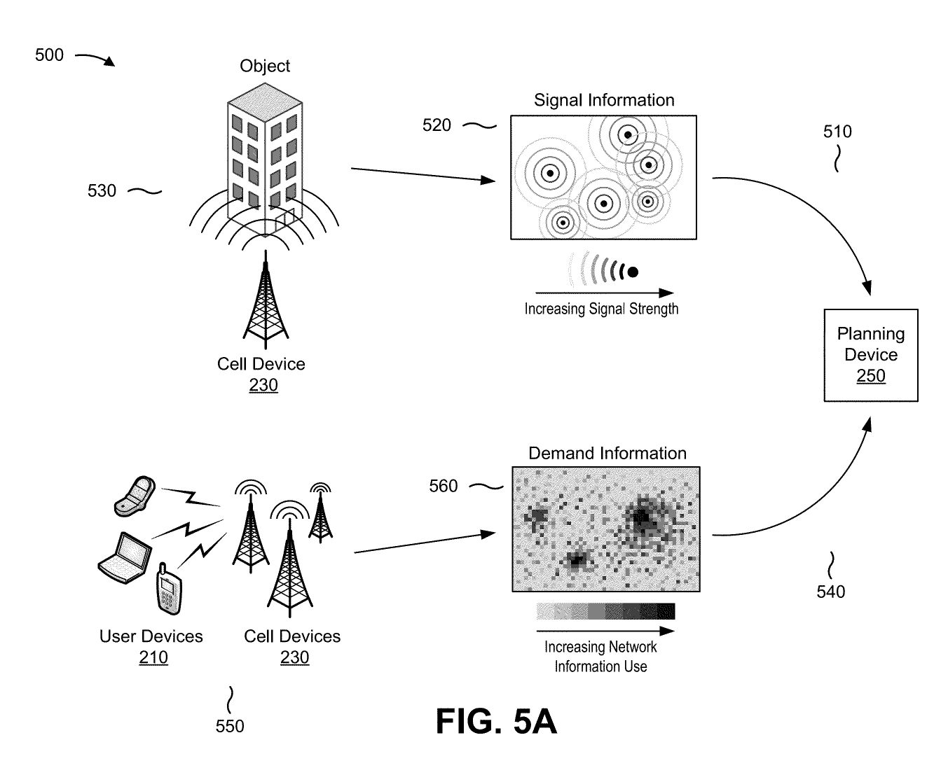

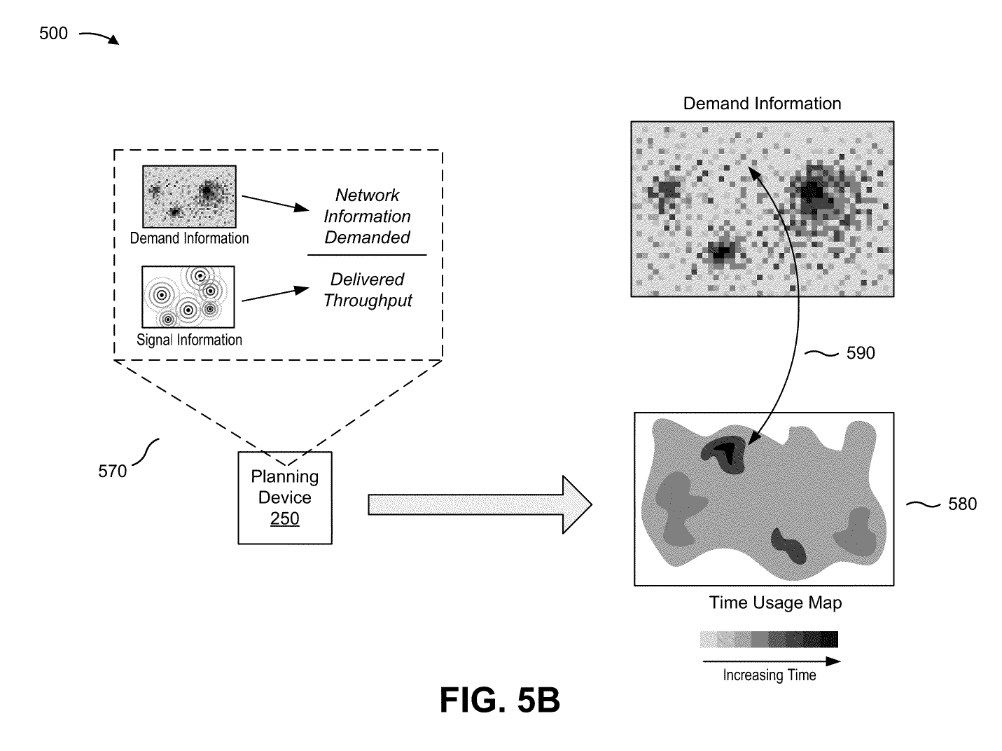

FIGS. 5A-5B are diagrams of an example implementation 500 relating to process 400 (FIG. 4). In example implementation 500, planning device 250 may determine time usage information based on signal information and based on demand information associated with a set of cell devices 230.

As shown in FIG. 5A, and by reference number 510, planning device 250 may receive signal information associated with the set of cell devices 230. As shown by reference number 520, the signal information may include information that identifies properties associated with the set of cell devices 230, such as locations, signal strengths, or the like. As shown by reference number 530, the signal information may include topographical information, such as information identifying an object (e.g., a building) in the path of a signal associated with cell device 230.

As shown by reference number 540, planning device 250 may receive demand information associated with the set of cell devices. As shown by reference number 550, the demand information may include a quantity of network information, transmitted between a set of user devices 210 and the set of cell devices 230, during a period of time. As shown by reference number 560, the demand information may include a measure of the aggregated demand information based on geographic location associated with the set of user devices (e.g., an aggregated quantity of network information transmitted from and/or received from a set of geographic locations).

As shown in FIG. 5B, and by reference number 570, planning device 250 may determine time usage information based on the demand information and based on the signal information. The time usage information may include a quantity of network information demanded per delivered throughput. Planning device 250 may determine the time usage information associated with a set of geographic locations (e.g., a geographic region associated with the set of cell devices 230).

As shown by reference number 580, planning device 250 may generate a map of the time usage information (e.g., a time usage map). The time usage map may display the time usage information, with darker regions corresponding to geographic regions where network information is transmitted slowly (e.g., below a threshold value) between user devices 210 and cell devices 230. As shown by reference number 590, the time usage map may reveal a geographic region associated with a slow network information transmission, even though the demand for the network information associated with the geographic region is not high.

As indicated above, FIGS. 5A-5B are provided merely as an example. Other examples are possible and may differ from what was described with regard to FIGS. 5A-5B.

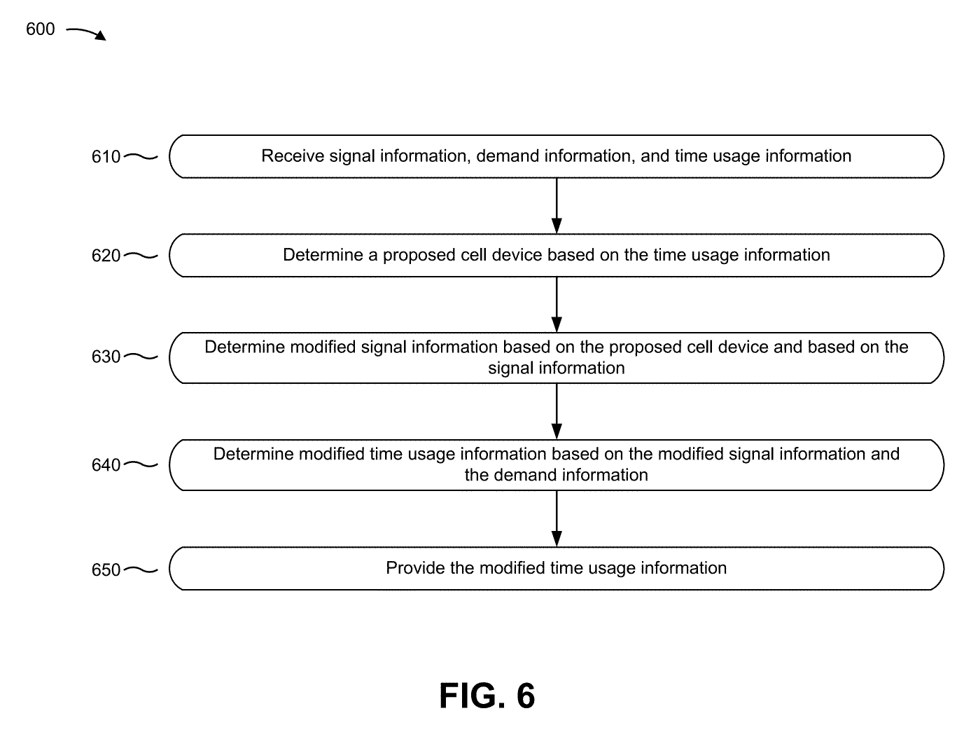

FIG. 6 is a flow chart of an example process 600 for determining time usage information associated with a proposed cell device. In some implementations, one or more process blocks of FIG. 6 may be performed by planning device 250. Additionally, or alternatively, one or more process blocks of FIG. 6 may be performed by another device or a group of devices separate from or including planning device 250, such as user device 210, cell device 230, and/or information server device 240.

As shown in FIG. 6, process 600 may include receiving signal information, demand information, and time usage information (block 610). For example, planning device 250 may receive the signal information, the demand information, and/or the time usage information from information server device 240. Additionally, or alternatively, planning device 250 may receive the signal information, the demand information, and/or the time usage information by accessing the signal information, the demand information, and/or the time usage information from a data structure. For example, planning device 250 may receive the signal information, the demand information, and/or the time usage information generated according to process 400 (FIG. 4) and stored in a data structure associated with planning device 250.

As further shown in FIG. 6, process 600 may include determining a proposed cell device based on the time usage information (block 620). For example, planning device 250 may determine the proposed cell device based on the time usage information received from information server device 240.

In some implementations, planning device 250 may determine the proposed cell device based on user input. For example, a user of planning device 250 (e.g., an engineer) may provide user input to planning device 250 (e.g., via a user interface). The user input may specify a location of the proposed cell device 230, a type associated with proposed cell device 230 (e.g., a cell device 230 for a small cell, a cell device 230 for a large cell, etc.), or the like. In some implementations, the user input may be based on the usage information. For example, planning device 250 may provide the usage information to the user (e.g., as a time usage map). The user may select a type of cell device 230 and/or a cell device location associated with cell device 230 based on the time usage information (e.g., the user may select a region of the time usage map corresponding to a region of the map where the ratio of network information demand to delivered throughput is below a threshold value).

In some implementations, planning device 250 may determine the proposed cell device based on the time usage information. For example, planning device 250 may identify a geographic region where network information demanded per delivered throughput satisfies a threshold. In some implementations, the region may correspond to a location associated with a high demand of network information and a low delivered throughput. Additionally, or alternatively, planning device 250 may determine the proposed cell device based on a location of an object (e.g., a building, a mountain, a hill, a tree, etc.), a location of cell devices 230 (e.g., a geographic location, a height, a direction, etc.), or the like.

In some implementations, planning device 250 may determine the proposed cell device based on a location, an availability, a proximity, or the like, of other networks and/or other portions of network 220 (e.g., based on backhaul information). For example, planning device 250 may determine a geographic location of proposed cell device 230 based on proximity to another portion of network 220.

As further shown in FIG. 6, process 600 may include determining modified signal information based on the proposed cell device and based on the signal information (block 630). For example, planning device 250 may determine the modified signal information based on a geographic location of proposed cell device 230 and/or a device type associated with cell device 230. Additionally, or alternatively, planning device 250 may determine the modified signal information based on the signal information associated with the set of cell devices 230.

In some implementations, the modified signal information may include information that describes properties of a signal (e.g., an electromagnetic signal, an RF signal, a cellular signal, etc.) associated with proposed cell device 230. For example, the signal information may include properties associated with a signal of proposed cell device 230, such as a signal strength, a signal intensity, a signal frequency, a power output, or the like.

In some implementations, planning device 250 may determine the modified signal information based on properties associated with proposed cell device 230, such as a type of proposed cell device 230 (e.g., a small cell, a macro cell, etc.), a location of proposed cell device 230 (e.g., a geographic location, a height, a direction, etc.), or the like. For example, planning device 250 may determine properties of the signal associated with proposed cell device 230 (e.g., a signal strength, a signal frequency, etc.) based on the properties associated with proposed cell device 230 (e.g., based on the location, type, etc.).

In some implementations, the modified signal information may include a measure of how the signal associated with proposed cell device 230 may affect a set of signals associated with the set of cell devices 230. For example, planning device 250 may determine to what extent the signal associated with proposed cell device 230 may interfere with the signal information associated with the set of cell devices 230.

In some implementations, the modified signal information may include a measure of how the signal associated with proposed cell device 230 may be affected by one or more artificial and/or natural physical features of a geographic region (e.g., a geographic region associated with proposed cell device 230). For example, planning device 250 may determine to what extent the signal associated with proposed cell device 230 may be affected by topographical information (e.g., associated with the signal information), such as buildings, mountains, hills, trees, or the like.

As further shown in FIG. 6, process 600 may include determining modified time usage information based on the modified signal information and the demand information (block 640). For example, planning device 250 may determine the modified time usage information based on the modified signal information associated with proposed cell device 230.

In some implementations, the modified time usage information may include a measure of an amount of time for the network information to be transmitted between user device 210 and proposed cell device 230.

In some implementations, planning device 250 may determine a proposed delivered throughput based on the modified signal information. For example, planning device 250 may determine a proposed signal quality experienced by user device 210 while transmitting and/or receiving network information (e.g., during a time of active use). Planning device 250 may determine the proposed delivered throughput based on the proposed signal quality.

In some implementations, planning device 250 may determine the modified time usage information based on the demand information. For example, planning device 250 may determine a proposed average amount of network information processed by a proposed set of cell devices 230 (e.g., the proposed set of cell devices 230 including the set of cell devices 230 and proposed cell device 230). Based on the proposed average amount of network information, planning device 250 may determine a proposed effective average total transmitted power associated with the proposed set of cell devices 230. Planning device 250 may determine SINRs, associated with the proposed set of cell devices 230, based on the proposed total transmitted power and based on the modified signal information (e.g., based on signal levels associated with the proposed set of cell devices 230 in a geographic location). Planning device 250 may spatially correlate the SINRs with the demand information. Based on the spatially correlated SINRs and the demand information, planning device 250 may determine the proposed delivered throughput associated with the proposed set of cell devices 230 in a geographic region (e.g., planning device 250 may determine a quantity of network information transmitted and/or received by proposed cell device 230 associated with a set of geographic locations). In this manner, planning device 250 may determine the modified time usage information (e.g., the quantity of network information demanded per delivered throughput).

As further shown in FIG. 6, process 600 may include providing the modified time usage information (block 650). For example, planning device 250 may provide the modified time usage information to another device and/or set of devices, such as user device 210, cell device 230, and/or information server device 250.

In some implementations, planning device 250 may display the modified time usage information on a display associated with planning device 250 (e.g., via a user interface). In some implementations, planning device 250 may display the modified time usage information as a map (e.g., a modified time usage map). For example, planning device 250 may display the modified time usage information as a map of geographic locations, with darker regions of the map displaying a higher quantity of time for transmitting and/or receiving network information. In some implementations, the modified time usage map may display related information (e.g., related modified signal information, related demand information, etc.). For example, planning device 250 may display, along with the time usage map, a location associated with proposed cell device 230, a type associated with proposed cell device 230, a quantity of network information processed by proposed cell device 230 (e.g., a load), an object, an object location, or the like.

In some implementations, planning device 250 may provide the modified signal information and/or the demand information. For example, planning device 250 may provide a map of the modified signal information and/or a map of the demand information. In some implementations, the map of the modified signal information and the map of the demand information may be associated with (e.g., overlaid on) the time usage map.

Although FIG. 6 shows example blocks of process 600, in some implementations, process 600 may include additional blocks, different blocks, fewer blocks, or differently arranged blocks than those depicted in FIG. 6. Additionally, or alternatively, one or more of the blocks of process 600 may be performed in parallel.

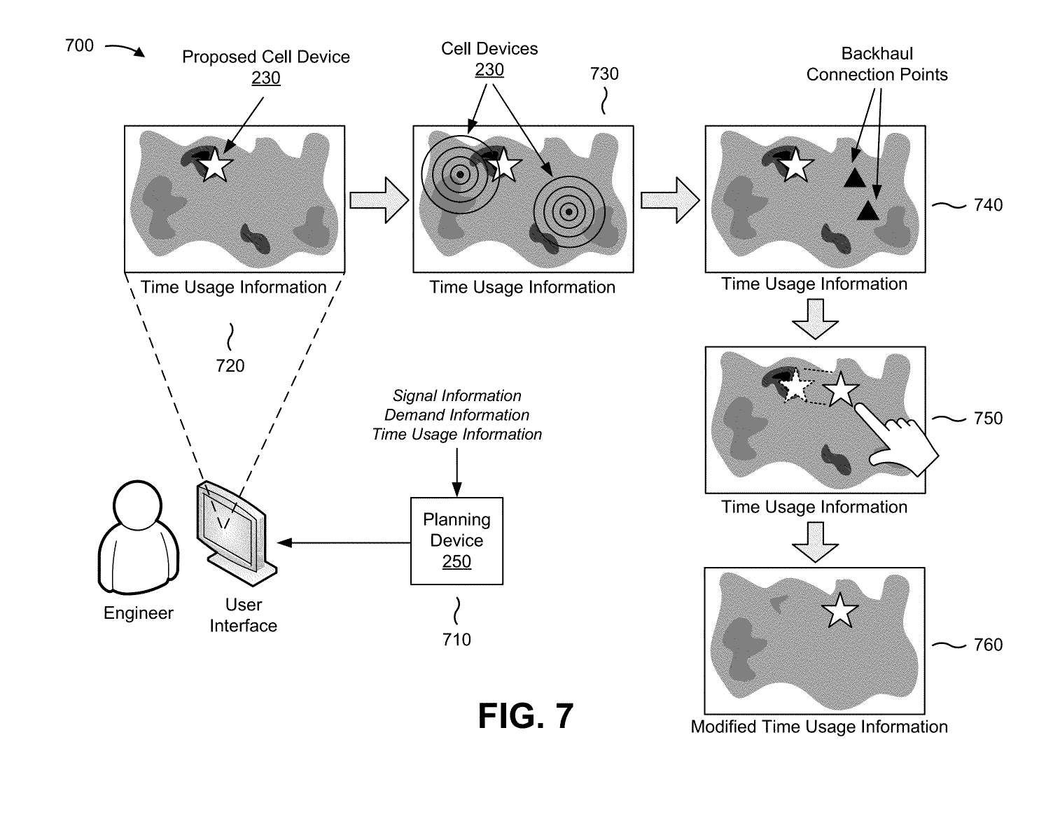

FIG. 7 is a diagram of an example implementation 700 relating to process 600 (FIG. 6). In example implementation 700, planning device 250 may determine proposed cell device 230, and may determine modified time usage information based on proposed cell device 230.

As shown by reference number 710, planning device 250 may receive signal information, demand information, and time usage information. Based on the signal information, planning device 250 may determine proposed cell device 230 (e.g., planning device 250 may determine a geographic location associated with proposed cell device 230 that corresponds to a region of the time usage information associated with a value of network information demanded per delivered throughput that is below a threshold value). Planning device 250 may display the time usage information, and geographic location associated with proposed cell device 230, on a user interface (e.g., associated with planning device 250), as shown by reference number 720.

As shown by reference number 730, planning device 250 may display signal information associated with the set of cell device 230 (e.g., geographic locations associated with cell devices 230). The signal information may allow an engineer (e.g., associated with planning device 250) to view cell devices 230 in proximity to proposed cell device 230. As shown by reference number 740, planning device 250 may display backhaul information (e.g., connection points to a core network). The backhaul information may allow the engineer to view backhaul connection points in proximity to proposed cell device 230.

As shown by reference number 750, the engineer may provide user information that identifies a new geographic location for proposed cell device 230. The new geographic location may be farther from a first cell device 230 (e.g., so as to reduce signal interference) and closer to a backhaul connection point (e.g., so as to reduce a cost of installing proposed cell device 230). The engineer may determine a device type associated with proposed cell device 230 (e.g., a cell device 230 for a small cell), and may identify a height and/or a direction associated with proposed cell device 230.

As shown by reference number 760, planning device 250 may determine modified time usage information based on proposed cell device 230. For example, planning device 250 may determine modified signal information (e.g., based on the geographic location, device type, height, direction, etc. of proposed cell device 230). Planning device 250 may use the modified signal information to determine modified time usage information (e.g., the time usage information that includes proposed cell device 230 among the set of cell devices 230). Planning device 250 may provide the modified time usage information for display on the user interface.

As indicated above, FIG. 7 is provided merely as an example. Other examples are possible and may differ from what was described with regard to FIG. 7.

Implementations described herein may allow a planning device to determine time usage information (e.g., information that identifies how quickly network information is transmitted between a set of user devices and the set of cell devices), and determine how the placement of a proposed cell device may affect signals associated with a set of cell devices based on the time usage information.

The foregoing disclosure provides illustration and description, but is not intended to be exhaustive or to limit the implementations to the precise form disclosed. Modifications and variations are possible in light of the above disclosure or may be acquired from practice of the implementations.

As used herein, the term component is intended to be broadly construed as hardware, firmware, or a combination of hardware and software.

Certain user interfaces have been described herein. In some implementations, the user interfaces may be customizable by a device or a user. Additionally, or alternatively, the user interfaces may be pre-configured to a standard configuration, a specific configuration based on capabilities and/or specifications associated with a device on which the user interfaces are displayed, or a set of configurations based on capabilities and/or specifications associated with a device on which the user interfaces are displayed.

Some implementations are described herein in conjunction with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc. depending on the context.

While the specification has used terms like “high,” “low,” “near,” “far,” etc., these terms are relative terms that are measured relative to a threshold or another item (e.g., a high item relative to a low item, a near item relative to a threshold, etc.).

It will be apparent that systems and/or methods, as described herein, may be implemented in many different forms of software, firmware, and hardware in the implementations illustrated in the figures. The actual software code or specialized control hardware used to implement these systems and/or methods is not limiting of the implementations. Thus, the operation and behavior of the systems and/or methods were described without reference to the specific software code—it being understood that software and hardware can be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Further, the phrase “based on” is intended to mean “based, at least in part, on” unless explicitly stated otherwise.

What is claimed is:

1. A device, comprising:
one or more processors to:
receive signal information associated with a plurality of cell devices in a network;
receive demand information associated with the plurality of cell devices;
determine time usage information based on the signal information and based on the demand information,
the time usage information including a measure of the demand, in the network, as a factor of time;
provide the time usage information;
determine a proposed cell device, for the network, based on the time usage information;
determine modified signal information based on the proposed cell device and based on the signal information,
the modified signal information being associated with the plurality of cell devices and the proposed cell device;
determine modified time usage information based on the modified signal information,
the modified time usage information including a measure of demand, in the network with the proposed cell device, as a factor of time; and
provide the modified time usage information.

2. The device of claim 1, where the one or more processors, when determining the proposed cell device, are further to:
receive user input; and
determine the proposed cell device based on the user input.

3. The device of claim 1, where the one or more processors, when determining the proposed cell device, are further to:
identify a geographic region associated with a time of transmission below a threshold time of transmission based on the time usage information; and
determine a device location associated with the proposed cell device,
the device location being within a threshold proximity of the geographic region.

4. The device of claim 1, where the one or more processors, when determining the proposed cell device, are further to:
determine the proposed cell device based:
a device type associated with the proposed cell device;
a device location associated with the proposed cell device; and
at least one of:
a device height associated with the proposed cell device; or
a device direction associated with the proposed cell device.

5. The device of claim 1, where the one or more processors, when determining the time usage information, are further to:
determine a quantity of network information transmitted between a cell device, of the plurality of cell devices, and a user device;
determine a rate of delivered throughput associated with the cell device; and
determine the time usage information based on the quantity of network information and the delivered throughput.

6. The device of claim 1, where the one or more processors, when providing the modified time usage information, are further to:
determine a map that visually depicts the modified time usage information; and
provide the map.

7. The device of claim 1, where the one or more processors, when providing the modified time usage information, are further to at least one of:
provide the signal information;
provide the modified signal information; or
provide the demand information.

8. A computer-readable medium storing instructions, the instructions comprising:
one or more instructions that, when executed by one or more processors, cause the one or more processors to:
determine signal information associated with a plurality of cell devices in a network;
determine demand information associated with the plurality of cell devices;
determine time usage information based on the signal information and based on the demand information,
the time usage information including a measure of the demand, in the network, as a factor of time;
determine a proposed cell device, for the network, based on the time usage information;
determine modified signal information based on the proposed cell device and based on the signal information,
the modified signal information being associated with the plurality of cell devices and the proposed cell device;
determine modified time usage information based on the modified signal information,
the modified time usage information including a measure of demand, in the network with the proposed cell device, as a factor of time; and
provide the modified time usage information.

9. The computer-readable medium of claim 8, where the one or more instructions, that cause the one or more processors to determine the proposed cell device, further cause the one or more processors to:
receive user input; and
determine the proposed cell device based on the user input.

10. The computer-readable medium of claim 8, where the one or more instructions, that cause the one or more processors to determine the proposed cell device, further cause the one or more processors to:
identify a geographic region associated with a time of transmission below a threshold time of transmission based on the time usage information; and
determine a device location associated with the proposed cell device,
the device location being within a threshold proximity of the geographic region.

11. The computer-readable medium of claim 8, where the one or more instructions, that cause the one or more processors to determine the proposed cell device, further cause the one or more processors to:
determine the proposed cell device based on:
a device type associated with the proposed cell device;
a device location associated with the proposed cell device; and
at least one of:
a device height associated with the proposed cell device; or
a device direction associated with the proposed cell device.

12. The computer-readable medium of claim 8, where the one or more instructions, that cause the one or more processors to determine the time usage information, further cause the one or more processors to:
determine a quantity of network information transmitted between a cell device, of the plurality of cell devices, and a user device;
determine a rate of delivered throughput associated with the cell device; and
determine the time usage information based on the quantity of network information and the delivered throughput.

13. The computer-readable medium of claim 8, where the one or more instructions, that cause the one or more processors to provide the modified time usage information, further cause the one or more processors to:
determine a map that visually depicts the modified time usage information; and
provide the map for display.

14. The computer-readable medium of claim 8, where the one or more instructions, that cause the one or more processors to provide the modified time usage information, further cause the one or more processors to at least one of:
provide the signal information;
provide the modified signal information; and
provide the demand information.

15. A method, comprising:
receiving, by a device, signal information associated with a plurality of cell devices in a network,
the signal information including properties of a signal associated with the plurality of cell devices;
receiving, by the device, demand information associated with the plurality of cell devices,
the demand information including a quantity of network information demanded during a period of time;
determining, by the device, time usage information based on the signal information and based on the demand information,
the time usage information including a measure of the demand, in the network, as a factor of time;
determining, by the device, a proposed cell device for the network;
determining, by the device, modified signal information based on the proposed cell device and based on the signal information,
the modified signal information being associated with the plurality of cell devices and the proposed cell device;
determining, by the device, modified time usage information based on the modified signal information,
the modified time usage information including a measure of demand, in the network with the proposed cell device, as a factor of time; and
providing, by the device, the modified time usage information.

16. The method of claim 15, where determining the time usage information further comprises:
identifying a geographic region associated with a time of transmission below a threshold time of transmission based on the time usage information; and
determining a device location,
the device location being within a threshold proximity of the geographic region; and
recommending the proposed cell device based on the device location.

17. The method of claim 16, where recommending the proposed cell device further comprises:
recommending the proposed cell device based on at least one of:
a device type associated with the proposed cell device;
a device location associated with the proposed cell device;
a device height associated with the proposed cell device; and
a device direction associated with the proposed cell device.

18. The method of claim 15, where determining the time usage information further comprises:
determining a quantity of network information transmitted between a cell device, of the plurality of cell devices, and a user device;
determining a rate of delivered throughput associated with the cell device; and
determining the time usage information based on the quantity of network information and the delivered throughput.

19. The method of claim 15, where providing the modified time usage information further comprises:
determining a map that visually depicts the modified time usage information; and
providing the map.

20. The method of claim 15, where providing the modified time usage information further comprises:
providing the modified signal information; and
providing at least one of:
the signal information; or
the demand information.
